(19) United States
(12) Patent Application Publication
(10) Pub. No.: US 2008/0243734 A1
(43) Pub. Date: Oct. 2, 2008

(54) Method for computer-assisted processing of measured values detected in a sensor network

(76) Inventors: Gustavo Deco, Vilassar De Mar (ES); Martin Stetter, Munchen (DE); Linda Tambosi, Trento (IT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/077,134

(22) Filed: Mar. 17, 2008

(30) Foreign Application Priority Data
Mar. 27, 2007 (DE) 10 2007 014 650.9

(51) Int. Cl. G06N 3/08

(52) U.S. Cl. 706/16

(57) ABSTRACT

There is described a method for computer-assisted processing of measured values detected in a sensor network, with the sensor network comprising a plurality of sensor nodes, which each feature one or more sensors for detection of the measured values, with the measured values of a number of adjacent sensor nodes being known in a sensor node. A multi-area neural network will be mapped onto a corresponding sensor network by the inventive method, which creates the opportunity, with the aid of the information from adjacent sensors, even with incorrect or failed measurements of a sensor node, of guaranteeing detection of a global situation at the location of the sensor node. A sensor network operated with such a method is in such cases more robust against the failure of a few sensors, since a corresponding measured value can be estimated in a suitable way, so that the measurement not available can be replaced by the estimated measured value. The individual sensors of the sensor nodes can thus be of a simpler construction with the same level of robustness of the sensor network, since failures of sensors have less effect on the functional integrity of the sensor network.

### CROSS REFERENCE TO RELATED APPLICATIONS

This application claims priority of the German application No. 10 2007 014 650.9 DE filed Mar. 27, 2007, which is incorporated by reference herein in its entirety.

### FIELD OF INVENTION

The invention relates to a method for computer-assisted processing of measured values detected in a sensor network as well as to a corresponding sensor network and a corresponding computer program product.

### BACKGROUND OF INVENTION

The invention generally relates to a sensor network comprising a plurality of sensor nodes with each sensor node featuring one or more sensors for detection of any given measured values in each case. The individual sensor nodes are at least partly networked together in this case via corresponding communication links, for example wirelessly or by wire. In particular a respective sensor node with can communicate with a number of adjacent sensor nodes in such a fashion that the respective measured values determined can be exchanged between the sensor nodes. The measured values detected can be any process variables, for example a temperature value at the location at which the sensor node is placed, or other physical variables, such as air humidity, incident light, development of smoke and such like.

Failures of sensor nodes can arise in sensor networks which seriously affect the functional integrity of the network. On failure of a sensor node it is therefore necessary for the correct functioning of the network for the corresponding sensor node to be repaired or replaced by a new correctly-functioning sensor node. However this takes a long time, so that the sensor network only has restricted functions within this period. It is therefore desirable, in a sensor network, even in the event of the failure of one sensor node, for essentially the full functional capability of the network to be guaranteed.

In addition known sensor networks always measure only local measured values, without the information of adjacent sensor nodes being taken into account in such cases in the evaluation of a measured value, although this information is available to the sensor nodes. Irregularities in the measurements can thus not be detected by global evaluation of local measured values.

Publication US 2005/0251291 A1 describes a system of self-organizing networks of mobile robot agents, with the system using different artificial unintelligence technologies, comprising artificial neural networks.

The publication Albrecht Schmidt: “A Modular Neural Network Architecture with Additional Generalization Abilities for High Dimensional Input Vectors”, Pgs. I-x & 1-113, Manchester Metropolitan University, September 1996, eHB, describes different neural network architectures and in particular discusses modular artificial neural networks.

The German seminar paper: “Neuronale Netze in der Robotik” (Neural Networks in Robotics), P. 1-20, TU-Clausthal, 19.01.2002,http://www2.in.tu-clausthal.de/˜reuter/ausarbeitung/Elke_von_Lienen_-_Neuronale_Netze_in_der_Robotik.pdf;eHB, describes the general use of neural networks in robotics.

### SUMMARY OF INVENTION

An object of the invention is therefore to create a method for computer-assisted processing of measured values detected in a sensor network, with which a global situation in the sensor network can be detected from local and partly incomplete measurements.

This object is achieved by the independent claims. Developments of the invention are defined in the dependent claims.

In the inventive method each sensor node is allocated a neuron area, comprising a plurality of neuron groups with one or more neurons identified by activities, with each neuron group being assigned a measured value and/or measured value range of the measured values measurable in the sensor node. The individual neuron groups of adjacent sensor nodes are in this case networked with each other, with correlation between the measured values of a respective sensor node and the measured values of the adjacent sensor nodes being represented by weights which are learned with a learning method and lie in each case between a neuron group of the respective sensor node and a neuron group of an adjacent sensor node. The learning method used in particular in this case is a learning method which, for the presence of correlation between neuron groups, i.e. for the presence of simultaneous activities of different neuron groups, increases the corresponding weight between the neuron groups. In a preferred embodiment in this case a Hebbian learning method will be used.

Hebbian learning methods are sufficiently known in such cases from the prior art (see for example publication [1]).

In the inventive method an input signal is applied to the neuron groups of a respective sensor node in each case, with the input signal including a first signal which depends on the weights between the respective neuron group and the neuron group of the adjacent sensor node as well as on the activities of the neuron groups of the adjacent sensor nodes. Furthermore in the case of a measured value in a respective sensor node being able to be measured at a measurement time, the neuron group to which the measured value or the corresponding measurement value range which has been measured is assigned is further fed a second signal. This second signal thus shows that the sensor node has conducted a measurement. By feeding the signal to the corresponding neuron group which corresponds to the measured value or to which the range of measured values is assigned in which the measured value lies, the activity of this neuron group is strengthened. In this case the activity is categorized into the states active and inactive, with the second signal being large enough to put the neuron group at which the second signal is present into the active state.

Inventively this means that in a neuron area not only local measured values are taken into account but the measured values of adjacent sensor nodes flow also via the activities of the neuron groups of this sensor node as well as via the corresponding learnt weights. Via the activities of the neuron groups of the respective sensor nodes and/or the adjacent sensor nodes a deviation from normal operation of the respective sensor node and/or a deviation from the normal state of the environment of the respective sensor node and/or an estimation of the measured value of the respective sensor node is determined.

A multi-area neural network is mapped on to a sensor network by the inventive method, which creates the opportunity, with the aid of adjacent sensor nodes, even with incorrect or failed measurements of a sensor node, to guarantee a global recognition of the situation at the location of the sensor node. A sensor network operated with such a method is in this case more robust in respect of the failure of a sensor, since a corresponding measured value can be estimated in a suitable manner, so that the non-available measurement can be replaced by the estimated measured value. The individual sensors of the sensor nodes can thus be of a simpler construction with the same level of robustness of the sensor network, since failures of sensors have less effect on the functional integrity of the sensor network.

In an embodiment of the inventive method the weights between the neuron groups of the sensor node are learnt continuously during execution of the method. Alternatively it is also possible for the weights to be learnt in advance and to be kept constant during the execution of the method.

With the inventive method for example the failure of a sensor node can be detected via the mapping of the sensor network onto a neural network. This is done by a failure being established if none of the neuron groups of the corresponding sensor node is active, which is to be equated with the fact that no measured values are determined from the respective sensor node. Form this it can be concluded that the sensor node is not functioning correctly or has failed.

In an especially preferred embodiment of the inventive method an adjustable global background signal is fed to the neuron area of a respective sensor node. The change in such a background signal enables the characteristics of the neuron areas to be suitably influenced. A neural network with a modifiable background signal is for example known in publication [2] as well as in the Patent Application DE 10 2005 045 120.9.

The global background signal is adjusted in an embodiment of the inventive method during the operation of the sensor network, especially after the detection of the failure of a sensor node such that precisely one neuron group is in the active state. After this adjustment the measured values or the measured value ranges assigned to the active neuron group represent the estimation of the measured value. In this way an appropriate determination of the estimated measured value is obtained even on failure of a sensor node by appropriate setting of the background signal, with the estimated measured value being influenced via the inputs of the adjacent sensor nodes (i.e. via the first signal). Thus, in this embodiment, use is made of the correlation of adjacent sensor nodes to the extent that measured values can be suitably estimated by this.

The method in accordance with the invention, as well as for the failure of a sensor node, can also be used in normal operation for estimation of a measured value. In such cases in a respective sensor node the first signal is exclusively applied as the input signal in each case to the neuron groups of the respective sensor node, with the measured value and/or measured value range of that neuron group which is active because of the application of the first signal representing the estimation of the measured value. This variant of the invention requires the adjustment of the global background signal such that precisely one neuron group of the respective sensor node is active.

The measured value can if necessary also be estimated in another way without variation of the background signal. In one variant the measured value or measured value range of that neuron group containing the largest signal is used as the estimated measured value. The focus of the distribution of the first signals over the neuron groups of the respective sensor node can likewise be determined, with the measured value or measured value range of the neuron group at which the focus lies representing the estimation of the measured value.

In a further variant the estimation of the measured value consists of normalizing the distribution of the first signal across the neuron groups of the respective sensor node to a probability distribution and of determining the estimation of the measured value by sampling with this probability distribution. This variant also takes account of imprecise measurements or measurement errors of adjacent sensor nodes via the generated probability distribution.

In a variant of the invention in which the distribution of the first signals is standardized via the neuron group of the respective sensor node to a probability distribution, the level of probability at the point of the actual measured value of the respective sensor node (i.e. at the position of the neuron group to which the actual measured value is assigned) is used as a criterion for the deviation from the normal state of the environment of the sensor node. Preferably this criterion in such cases is the reciprocal of the level of probability at the position of the actual measured value.

With the variants described above a deviation from the normal operating state of the respective sensor node or from the normal state of the measured environmental variables can be established. Such a deviation is established in particular if the estimation of the measured value deviates by more than a predetermined threshold value from the actual determined measured value of the respective sensor node.

Any sensors can be used as sensors in the sensor network, for example temperature sensors and/or brightness sensors and/or humidity sensors and suchlike.

The inventive method can be used in any sensor network in any technical areas, for example with sensor networks in buildings for fire monitoring or for monitoring high-voltage lines or for monitoring of transport or logistics systems. A further area of application is for example monitoring the storage of foodstuffs or medicine, in which the temperature or the humidity of the foodstuffs or medicine is measured. A further area of application is the use of the method in production plants in which the operation of a production line is monitored with the sensor network.

As well as the method described above, the invention further relates to a sensor network which is embodied in such a way as to enable the inventive method to be executed in the sensor network. Above and beyond this the invention includes a computer program product with program code stored on a machine-readable medium for executing the inventive method, when the program runs on a computer, especially in a sensor node.

### BRIEF DESCRIPTION OF THE DRAWINGS

Exemplary embodiments of the invention will be described in detail below with reference to the enclosed figures.

The figures show:

FIG. 1 a schematic diagram of a part of a sensor network with sensor nodes communicating with each other;

FIG. 2 a schematic diagram which illustrates the learning of the weights between the sensor nodes in accordance with a variant of the inventive method; and

FIG. 3 a schematic diagram of an embodiment of a neuron area used in the sensor nodes of the of the sensor network.

### DETAILED DESCRIPTION OF INVENTION

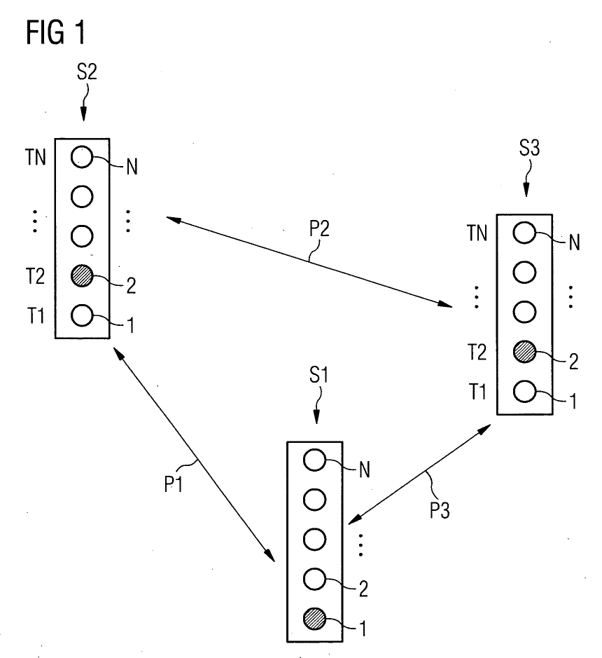

FIG. 1 shows a schematic diagram of a section from a sensor network, in which the method in accordance with the invention is used. The section shown comprises three sensor nodes S1, S2 and S3, which can communicate with each other, as indicated by the double-ended arrows P1, P2 and P3. The sensor network in this case contains further sensor nodes which are not reproduced in FIG. 1. In the embodiment described here each sensor node comprises a temperature sensor which can measure temperatures T1, T2, . . . to TN.

In accordance with the inventive method a neuron area is embodied in each of the sensor nodes S1, S2 and S3, which represents an emitted cortex area which in a sparse topographical code represents the instantaneous measured temperature of the sensor node. In other words this means that each sensor node is assigned a neuron area with a plurality of neuron pools or neuron groups 1, 2, . . . , N, with each neuron group representing a corresponding temperature T1, T2, . . . , TN. The temperature in this case does not have to be a fixed temperature value but can also represent a specific range of temperature values.

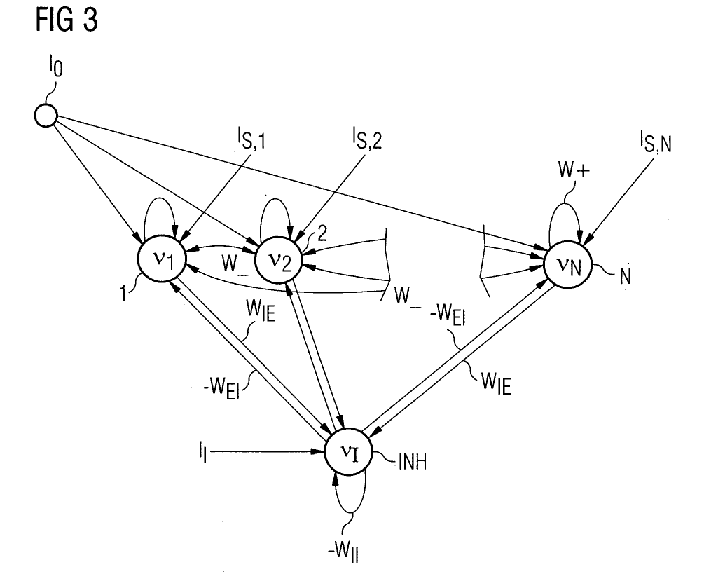

Each of the neuron pools 1 through N receives corresponding input signals I_{s,1} through I_{s,N} (see FIG. 3), with which the pools can be activated. In the example depicted in FIG. 1 the activated neuron pools are indicated by cross-hatched areas. In particular pool 2 is active in sensor nodes S2 and S3, whereas in sensor node S1 it is pool 1 which is active. In the embodiment described here the activities of the individual pools are binary coded, i.e. a pool is in an active state if a specific level of activity is exceeded and otherwise it is in an inactive state. For a functioning sensor node a corresponding signal is emitted in this case, when the corresponding temperature value is being measured, to that neuron pool which represents the measured temperature value. This signal is subsequently referred to as the sensor signal and corresponds to the second signal in the sense of the claims.

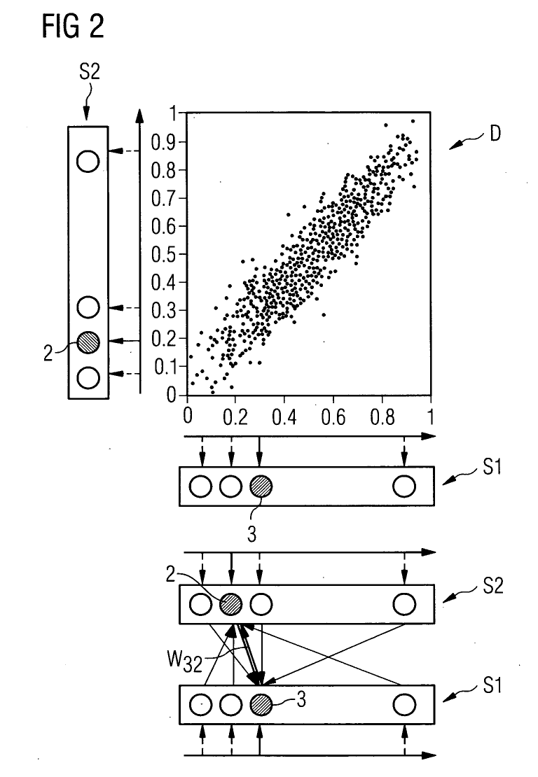

In addition all pools receive signals from their adjacent sensor node, with the signals being a weighted sum of the activities of the other pools. The signals of the adjacent sensor nodes which are received in a respective sensor node are also referred to a lateral input. In the example depicted in FIG. 1 for example the sensor node S2 thus receives an input signal with corresponding weights from the active pool 2 of the sensor node S3 as well as in addition an input signal with corresponding weights from the active pool 1 of the sensor node S1. The neuron pool 2 further receives the sensor signal from the sensor node S2 as the sole pool of this sensor node, since the temperature T2 is measured in the node S2. The weights mentioned above are learnt in this case so that correlation between the measured temperatures of the individual sensors can be suitably taken into account, as described below with reference to FIG. 2.

FIG. 2 illustrates the Hebbian leaning method in the embodiment described here, which corresponds to the learning method described in publication [1]. In the Hebbian learning method weights are strengthened between such neuron pools of different sensor nodes as are simultaneously active. In FIG. 2, in the diagram D shown, a data record reflecting a plurality of measured values of the sensor nodes S1 and S2 of FIG. 1 is reproduced. The values of the individual measurements are in this case mapped on a scale between 0 on 1, with the measured values of the sensor node S1 being reproduced along the abscissa and the measured values of the sensor node S2 along the ordinate. The two measured values are linked together via a positively correlated Gaussian distribution, with the average value of the Gaussian distribution essentially lying along the diagonals in the coordinate system of diagram D. The weights are now learnt with the aid of such a data record, with in FIG. 2 for example a measuring point being observed in which neuron pool 3 of sensor node S1 is active and neuron pool 2 of sensor node S2 is active. Because of the simultaneous activity of the two neuron pools the corresponding weight between neuron pool 3 of S1 and neuron pool 2 of S2 will then be strengthened by Hebbian learning. This is indicated by the bold arrows in the lower part of FIG. 2. The weight in this case is represented as a corresponding matrix entry W₃₂ in the Hebbian matrix, with the Hebbian matrix containing all possible weights between the neuron pools of sensor node S1 and S2. In addition further correlations between neuron pools are indicated by additional lines between S1 and S2 in the lower part of FIG. 2. The Hebbian matrix is thus built up by Hebbian learning with corresponding weights Wᵢⱼ (I, j=1, . . . , N) between the individual neuron pools. In this case the corresponding lateral input is defined in a neuron pool of a sensor node by the weights.

Mathematically the input signal for any given neuron pool I of a sensor node can be written as follows.

$${I}_{S , i} = I + {\sum }_{j} {W}_{ij} {v}_{j} \qquad ( 1 )$$

In this case I is the sensor signal which is only entered in the corresponding pool I if a corresponding, measured value represented by the neuron pool actually exists. The sum of equation (1) in this case extends over all neuron pools of adjacent sensor nodes, i.e. of sensor nodes which communicate with the observed sensor node. νⱼ in this case is the activity of the corresponding neuron pool j of an adjacent sensor node, in which case it should be taken into consideration that the activities are binary coded, i.e. νⱼ=1, if pool j is active and otherwise 0.

In a functional sensor node the sensor signal I will be selected in this case such that the sensor signal alone leads to an activation of the corresponding pool, whereas the value of the sum in equation (1) is significantly smaller and is not sufficient alone for activating a pool. In this way failures of a sensor node can be established whenever it is detected that none of the neuron pools of the neuron area of the corresponding sensor node exhibits an activity. In this case no temperature will in fact be measured by the sensor node, which in the final analysis allows it to be concluded that the sensor node has failed.

In a preferred variant of the Hebbian learning described above a corresponding weight Wₘₙ is amplified between two neuron pools m and n of different adjacent sensor nodes then if the activities νₘ or νₙ exceed a specific threshold value, and otherwise the activity is not changed. The activity in this case is increased by the value ΔWₘₙ as follows:

$$Δ {W}_{mn} = \{ \begin{matrix}{q}_{+} \frac{{W}_{+} - {W}_{mn} ( t )}{2 {W}_{+}} , & if {v}_{n} , {v}_{m} > threshold value ( e . g . 0 , 5 ) \\ 0 & else\end{matrix} \qquad ( 2 )$$

In this case the term q₊ refers to the step width used in the Hebbian learning. q₊ is usually much smaller than 1, for example 0.01. In addition a maximum value for a weight is determined by the value W₊ and a minimum value for a weight is determined by the value W₋, with the minimum value W₋ being the negative value of W₊, i.e. W₋=−W₊.

The result of this, starting from the weight Wₘₙ(t) at the current point in time t as a new weight Wₘₙ(t+1) at the next point in time (t+1) is the following value:

$${W}_{mn} ( t + 1 ) = {W}_{mn} ( t ) + Δ {W}_{mn} - \frac{1}{N} {\sum }_{l = 1}^{N} Δ {W}_{m l} \qquad ( 3 )$$

In the summand at the end of the equation (3) the changes of all weights linked to the neuron pool m is summed, and by this a standardization is achieved such that on average a constant input in the form of a background signal for each pool is reached.

The learning method described above is only one example of a Hebbian learning method and any other variant of Hebbian learning methods can be used. The final deciding factor is that the learning method is embodied such that weights are amplified between neuron pools of different sensor nodes, which are simultaneously active. This can possibly also be achieved by Hebbian learning methods.

In the embodiment of the invention described here for each sensor node of the sensor network a neuron area with adjustable background current or background signal is embodied. Such a neuron area is described for example publication [2]. The adjustable background signal in this case enables the characteristics of the individual neuron area to be changed, which can be used to perform an appropriate evaluation of the measured values of adjacent sensor nodes correlated with each other. In one variant of the inventive method for example, if a sensor node fails for example the background signal is increased long enough for a neuron area with a single active neuron pool to form. The measured value or the measured value range of those neuron pools which is active after the adjustment of the background signal, is then used as the estimated measured value. The operation of the sensor network can thus be continued, with the actual measured value now being replaced by the estimated measured value. The Inventors were able to prove by simulations that this type of estimated measured value is a very good match with the actual measured value measured during correct operation of the sensor node.

The estimation of a measured value just set down can also be used in a functioning sensor node in order to detect anomalies. Such anomalies can result with temperature sensors for example, from fire having broken out at the location, at which the temperature sensor is set up, which initially leads only an increase in the temperature restricted locally at the sensor node, whereas the other adjacent sensor nodes continue to show the normal temperature obtaining at the time. This anomaly can be established by the fact that an estimated measured value is continuously determined in accordance with the estimation presented above and compared to the actual measured value obtained. Should the deviation exceed a specific level a corresponding alarm is output.

A prerequisite of the estimation described above is that without the presence of a sensor signal in a neuron area the background current is increased until such time as precisely one neuron pool is active. This is achieved by the corresponding solution of the differential equation underlying the neuron area. There is also the option however of determining anomalies without solving the differential equations. In particular the measured value can also be estimated without changing the background signal, by determining in a sensor node that neuron pool which receives the greatest lateral input. The measured value or range of measured values to which this neuron pool is assigned, is then used as an estimated measured value. Likewise the focal point of the distribution of the lateral inputs can be determined via the neuron pools, with the measured value of that neuron pool at which the focus lies being used as the estimated measured value. Above and beyond this it is possible for the distribution of lateral inputs over the neuron pools to be recorded as a probability distribution, with the estimated measured value being determined by sampling based on this probability distribution. In this way inaccuracies or errors in the measurements of adjacent sensor nodes can be taken into account in the estimation of the measured value.

As explained above, in the embodiment of the inventive method described here, each sensor node is modeled by a neuron area which receives a globally adjustable background current. A neuron area of this type is described in FIG. 3.

FIG. 3 shows a neuron area of artificial neurons with neuron pools 1, 2, . . . , N of exciting neurons, with each pool being characterized by the corresponding activities in the form of a spiking rate ν₁, ν₂, . . . , ν_{N} determined over all neurons in the pool. The spiking rate is a variable sufficiently known from the prior art. The outstanding feature of each pool is that it receives similar inputs and that all artificial neurons of the respective pool behave similarly. The specific inputs for each of the pools 1 to N correspond to input currents or input signals I_{s,1}, I_{s,2}, . . . , I_{s,N} for the respective pools 1, 2, . . . , N. The input currents in this case contain the lateral input of adjacent sensor nodes and where necessary a sensor signal (if the corresponding measured value of the neuron pool is measured) and are defined by the above equation (1).

The local connections of the artificial neurons in a pool are characterized by a heavy local synaptic weight w₊. By contrast the neurons between the individual pools exhibit weaker lateral synaptic weights with the value w₋. As well as the pools of exciting neurons there also exists a pool of so-called inhibiting neurons INH with the spiking rate ν_{I}. This inhibiting pool INH has a local excitation with the value −w_{II} and is fed via a global inhibiting current I_{I}. Furthermore this pool is coupled to the pools of the exciting neurons, in order to exercise a global inhibition on these exciting neurons. The coupling is undertaken via corresponding weights of the inhibiting pool to the exciting pools with the value −w_{EI} and of the exciting pools through to the inhibiting pool with the value w_{IE}. In the neural network input information is only supplied via the exciting pools through the corresponding input currents I_{S,1}, I_{S,2}, . . . , I_{S,N}. The exciting pools of the networks are also supplied with a global, modifiable input current I₀.

In the exemplary embodiment of the neuron area used in a sensor node described here the dynamics of the area are described via a mean field approximation known sufficiently from the prior art. The dynamics of the pool are approximated in this case by the following equation:

$$τ \frac{d}{d t} v ( t ) = - v ( t ) + g ( I ( t ) ) \qquad ( 4 )$$

In this case ν(t) is the averaged spiking rate over the respective pool, g(I) represents a so-called transfer function of the average input current I(t), and ô designates a time constant of the area.

The dynamics of the neural network which are used in the embodiment described here correspond to the dynamics described in publication [3]. This is described by the following equations:

$$\begin{matrix}τ \frac{d}{d t} {v}_{k} = - {v}_{k} + g ( {I}_{0} + {I}_{s , k} + {w}_{+} {v}_{k} + {\sum }_{l \neq k} {w}_{-} {v}_{l} - {w}_{EI} {v}_{I} ) , \\ k = 1 , … , N & ( 5 ) \\ {v}_{I} = {g}_{I} \cdot ( {I}_{I} + {\sum }_{k} {w}_{IE} {v}_{k} - {w}_{II} {v}_{I} ) & ( 6 )\end{matrix}$$

In this case I₀ is the global input current to the pools of the exciting neurons, I_{I} is the global input stream to the inhibiting pool, I_{s,k} (k=1, . . . , N) is the specific input stream to the respective pool k, and g_{I} is the rise of an inhibiting transfer function.

The global input current I₀ is in this case significant for the characteristics of the neural area. Therefore the embodiment of the invention described stands out in that this global input current can be adjusted for modifying characteristics of the neuron area. The processing property of the network on failure of a sensor node can especially be modified by this in a simple manner in that the behavior of the area is defined by the lateral input of the adjacent sensor node.

The equation (6) can be transformed as follows:

$${v}_{I} = {g}_{I} {I}_{I} + {g}_{I} {w}_{IE} {\sum }_{l} {v}_{l} - {g}_{I} {w}_{II} {v}_{l} ; \\ {v}_{I} = \frac{{g}_{I} {w}_{IE}}{1 + {g}_{I} {w}_{II}} {\sum }_{l} {v}_{l} + \frac{{g}_{I}}{1 + {g}_{I} {w}_{II}} {I}_{I} \qquad ( 7 )$$

With this transformation the dynamics in accordance with equation (5) can be written as follows:

$$\begin{matrix}τ \frac{d}{d t} {v}_{k} = - {v}_{k} + g ( {I}_{0} + {I}_{s , k} + {w}_{+} {v}_{k} + {\sum }_{l \neq k} {w}_{-} {v}_{l} - \\ \frac{{g}_{I} {w}_{EI} {w}_{IE}}{1 + {g}_{I} {w}_{II}} {\sum }_{l} {v}_{l} - \frac{{g}_{I} {w}_{EI}}{1 + {g}_{I} {w}_{II}} {I}_{I} ) , k = 1 , … , N \\ = - {v}_{k} + g ( ( {I}_{0} - \frac{{W}_{I}}{{w}_{IE}} {I}_{I} ) + {I}_{s , k} + ( {w}_{+} - {w}_{-} ) {v}_{k} + \\ ( {w}_{-} - {W}_{I} ) {\sum }_{l} {v}_{l} ) , {W}_{I} := \frac{{g}_{I} {w}_{EI} {w}_{IE}}{1 + {g}_{I} {w}_{II}}\end{matrix} \qquad ( 8 )$$

This produces the following differential equation system which, in the embodiment described here, is solved for determining the activities of the neuron pools of the neuron area

$$τ \frac{d}{d t} {v}_{k} = - {v}_{k} + g ( {I}_{b} + {I}_{s , k} + {W}_{S} {v}_{k} + \frac{{W}_{L}}{N} {\sum }_{l} {v}_{l} ) , k = 1 , … , N \\ with \\ {I}_{b} = {I}_{0} - \frac{{W}_{I}}{{w}_{IE}} {I}_{I} \qquad ( 9 )$$

being the so-called globally effective background current;

W_{S}=−w₊−w₋

being the superfluous local exciting (mostly greater than or equal to zero); and

W_{L}=N(w₋−W_{I})

being the effective lateral connection strength (which can change its leading sign).

### LITERATURE REFERENCES

[1] M. Szabo, M. Stetter, G. Deco, S. Fusi, P. Del Giudice, M. Mattia: “Learning to Attend: Modeling the Shaping of Selectivity in Infero-temporal Cortex in a Categorization Task”, Biological Cybernetics 94(5): 351-365 (2006)
[2] M. Stetter, “Dynamic functional tuning of nonlinear cortical networks”, Phys. Rev. E 73(3 Pt 1):031903.
[3] Mongillo, G., Amit, D. J. and Brunel, N. (2003): “Retrospective and prospective persistent activity Induced by Hebbian learning in a recurrent cortical network”, Eur. J. Neurosci. 18: 2011-2024.

1-19. (canceled)

20. Method for computer-assisted processing of measured values detected in a sensor network, comprising:
providing a plurality of sensor nodes for the sensor network, wherein a sensor node has one or more sensors for detection of the measured values, wherein the measured values of a plurality of adjacent sensor nodes are known in a sensor node;
providing a neuron area with a plurality of neuron groups identified by activities with one or more neurons, wherein the neuron area is assigned to one of the sensor nodes, wherein each neuron group is assigned to a measured value or range of measured values measured in the sensor node;
providing correlations between the measured values of a respective sensor node and the measured values of the adjacent sensor node, wherein the correlations are represented by weights, wherein the weights are learned based upon a learning method and lie between a neuron group of the respective sensor node and a neuron group of an adjacent sensor node;
applying an input signal in each case to the neuron groups of the respective sensor node, wherein the input signal has a first signal which depends:
on the weights between the respective neuron group and the neuron group of the adjacent sensor node as well as
on the activities of the neuron group of the adjacent sensor node,
wherein if a value is measurable in a respective sensor node at a measurement time, the neuron group, which is assigned to the measured value or to the corresponding range of measured values, is further supplied with a second signal;
placing the neuron group in an active state based upon the second signal applied to the neuron group, wherein the activity of a respective neuron group is divided up into an active and an inactive state; and
determining a deviation from normal operation of the respective sensor node or a deviation from the normal state of the environment of the respective sensor node or an estimation of the measured value of the respective sensor node based upon the activities of neuron group of the respective sensor node and/or of the adjacent sensor node.

21. The method as claimed in claim 20, wherein the weights are learnt based upon a Hebbian learning method.

22. The method as claimed in claim 20, wherein the weights are learnt continuously during an execution of the method.

23. The method as claimed in claim 20, wherein the weights are kept constant during the execution of the method.

24. The method as claimed in claim 20, wherein a failure of a sensor node is determined as a deviation from normal operation in that none of the neuron groups of the respective sensor node is active.

25. The method as claimed in claim 19, wherein the neuron area of a respective sensor node is supplied with an adjustable global background signal.

26. The method as claimed in claim 25, wherein the global background signal is adjusted during of the operation of the sensor network such that only one neuron group is in the active state.

27. The method as claimed in claim 24, wherein the global background signal is adjusted during of the operation of the sensor network such that only one neuron group is in the active state, and wherein after the detection of the failure of a sensor node the background signal is adjusted, wherein the measured values or range of measured values assigned to the active neuron group after the adjustment of the background signal represent the estimation of the measured value.

28. The method as claimed in claim 20, wherein for estimation of the measured value in a respective sensor node a first signal is applied as an input signal exclusively to the neuron group of the respective sensor node in each case, with the measured value or range of measured values of that neuron group, which is active as a result of the application of the first signal representing the estimation of the measured value.

29. The method as claimed in claim 20, wherein the measured value or range of measured values of that neuron group, which contains a largest first signal, represents the estimation of the measured value.

30. The method as claimed in claim 20, wherein the mean of the distribution of first signals over the neuron group of the respective sensor node is determined, with the measured value or range of measured values of the neuron group, at which the mean point lies representing the estimation of the measured value.

31. The method as claimed in claim 20, wherein the distribution of first signals over the neuron group of the respective sensor node is standardized to a probability distribution.

32. The method as claimed in claim 31, wherein by sampling with the probability distribution, the estimation of the measured value is determined.

33. The method as claimed in claim 31, wherein a level of probability is used instead of the actual measured value of the respective sensor node as a checking criterion for the deviation form the normal state of the environment of the respective sensor node.

34. The method as claimed in claim 33, wherein a reciprocal value of the level of probability of the actual measured value of the respective sensor node represents the checking criterion for the deviation from the normal state of the environment of the respective sensor node.

35. The method as claimed in claim 20, wherein a deviation from a normal operating state of the respective sensor node is established if the estimation of the measured value deviates by more than a predefined threshold value from the actual measured value of the respective sensor node.

36. The method as claimed in claim 20, wherein one of the sensors in the sensor network is selected from the group consisting of a temperature sensor, a brightness sensor and a humidity sensor.

37. A sensor network, comprising:
a plurality of sensor nodes having one or more sensors for detection of measured values, wherein the measured values of a number of adjacent sensor nodes are known in at least one of the sensor nodes; and
a neuron area with a plurality of neuron groups identified by activities with one or more neurons, wherein the neuron area is assigned to one of the sensor nodes, wherein each neuron group is assigned to a measured value or range of measured values measured in the sensor node.
